(19) United States
(12) Patent Application Publication
(10) Pub. No.: US 2011/0138317 A1
(43) Pub. Date: Jun. 9, 2011

(54) AUGMENTED REMOTE CONTROLLER, METHOD FOR OPERATING THE AUGMENTED REMOTE CONTROLLER, AND SYSTEM FOR THE SAME

(75) Inventors: Mingoo KANG, Seoul (KR); Haengjoon Kang, Seoul (KR); Sunjung Hwang, Seoul (KR); Jongsoon Park, Seoul (KR); Jinyung Park, Seoul (KR); Jongchul Kim, Seoul (KR); Junho Park, Seoul (KR)

(73) Assignee: LG Electronics Inc.

(21) Appl. No.: 12/959,730

(22) Filed: Dec. 3, 2010

Related U.S. Application Data
(60) Provisional application No. 61/266,944, filed on Dec. 4, 2009.

(30) Foreign Application Priority Data
Apr. 23, 2010 (KR) 10-2010-0038009

(51) Int. Cl. G06F 3/048; G06F 17/30; G09G 5/00

(52) U.S. Cl. 715/780; 345/156

(57) ABSTRACT

An image display may be displayed on a remote controller based on augmented reality. An electronic device may be identified having playable content. A window may be displayed for entering a keyword related to playable content in the identified target device. A search may be performed for content that corresponds to the received keyword entered through the window. An object may be displayed that represents determined content that corresponds to the received keyword.

### CROSS-REFERENCE TO RELATED APPLICATIONS

This application claims benefit and priority from Korean Patent Application No. 10-2010-0038009, filed Apr. 23, 2010 and U.S. Provisional Application No. 61/266,944, filed Dec. 4, 2009, the subject matters of which are incorporated herein by reference.

This application is also related to U.S. application Ser. No. ______ filed Dec. 3, 2010 (Attorney Docket No. PBC-0219) and U.S. application Ser. No. ______ filed Dec. 3, 2010 (PBC-0220), the subject matters of which are incorporated herein by reference.

### BACKGROUND

1. Field

Embodiments of the present invention may relate to an augmented remote controller, a method for controlling the augmented remote controller, and a system for the same. The augmented remote controller may identify an image display apparatus, an external device connectable to the image display apparatus, contents available from the image display apparatus or the external device, and/or other types of objects and the augmented remote controller may display related information. A user may control an object around the user and receive information related to the object using the augmented remote controller.

2. Background

An image display apparatus may display images viewable to a user. The user can view a broadcast program through the image display apparatus. The image display apparatus may be connected to an external device. The user can view contents available from the external device through the image display apparatus. The image display apparatus may also be connected to a content provider over a network. The user can view contents available from the content provider through the image display apparatus over the network.

An amount of content viewable to users through image display apparatuses and information related to the contents may be increasing. The users may want to view content-related information as well as contents through the image display apparatuses. The users may also want to efficiently control an image display apparatus and various types of external devices by use of a single remote controller.

### BRIEF DESCRIPTION OF THE DRAWINGS

Arrangements and embodiments may be described in detail with reference to the following drawings in which like reference numerals refer to like elements and wherein:

FIG. 1 is a block diagram of an augmented remote control system according to an exemplary embodiment of the present invention;

FIG. 2 is a block diagram of an augmented remote control system according to an exemplary embodiment of the present invention;

FIGS. 3 and 4 are block diagrams of an image display apparatus according to an exemplary embodiment of the present invention;

FIG. 5 is a block diagram of an augmented remote controller according to an exemplary embodiment of the present invention;

FIG. 6 is a flowchart illustrating a method for operating an augmented remote controller according to an exemplary embodiment of the present invention;

FIG. 7 illustrates an exterior of an augmented remote controller according to an exemplary embodiment of the present invention;

FIG. 8 is a flowchart illustrating a method for operating an augmented remote controller according to an exemplary embodiment of the present invention; and

FIGS. 9A to 16C are views for describing an operation of an augmented remote controller according to an exemplary embodiment of the present invention.

### DETAILED DESCRIPTION

Embodiments of the present invention may provide a remote controller for controlling an image display apparatus or an external device connected to the image display apparatus.

Embodiments of the present invention may provide a remote controller for enabling a user to efficiently use and manage contents and contents-related information played back or stored in an image display apparatus or in an external device connected to the image display apparatus.

A method may be provided for operating an augmented remote controller that has a screen including an image of a real environment and an object representing information related to the real environment, which includes identifying a target device to which a control command can be transmitted from among objects in the real environment. The method includes displaying a window, on the screen, for entering a keyword related to contents playable in the identified target device, searching for contents matching the keyword entered through the window, and displaying objects representing the detected (or determined) contents on the screen.

The terms “module”, “unit”, and “unit” attached to describe names of components may be used herein to help understanding of components, and thus should not be considered as having specific meanings or roles. Accordingly, the terms “module” and “unit” may be interchangeable in their use.

Embodiments of the present invention may be described with reference to an augmented remote controller. Embodiments are also applicable to other devices, such as pointing devices, goggles, and/or other devices with displays.

According to an exemplary embodiment, an augmented remote controller may identify an object around a user (or about a user) and provide information related to the identified object to the user, thereby offering an augmented reality environment to the user. The object around the user may be an image display apparatus that is controllable using the augmented remote controller, an external device connected to the image display apparatus, contents available from the image display apparatus or the external device, objects included in the contents (e.g. actors, goods, etc.), and/or other types of objects.

The augmented remote controller may identify an object around the user by collecting user-related information. For example, the augmented remote controller may collect information about location or bearing of the user using a Global Positioning System (GPS) or a compass. Further, the augmented remote controller may capture an image of a real environment of the user by a camera and thus identify an object around the user.

The augmented remote controller may also identify an object around (or about) the user using a Radio Frequency IDentification (RFID) reader.

The augmented remote controller may identify an object around (or about) the user, search for information related to the identified object, and display the detected (or determined) information. The type of the determined information may correspond to the type of the identified object.

For example, when the augmented remote controller identifies an image display apparatus or an external device around the user, the augmented remote controller may search for information regarding a content list available from the image display apparatus or the external device. Additionally, the augmented remote controller may search for information about a user interface through which the image display apparatus or the external device can be controlled. The augmented remote controller may display the determined information regarding the image display apparatus or the external device to the user.

The augmented remote controller may identify contents provided by an image display apparatus or an external device around the user. The augmented remote controller may search for information regarding contents and display determined information to the user. The augmented remote controller may display a user interface through which the user can edit, play back, and/or transmit contents provided by the image display apparatus or the external device.

The augmented remote controller may identify any other type of object around the user. For example, the user may capture an image of a piece of furniture around the user using a camera provided in the augmented remote controller. The augmented remote controller may identify that the object captured by the camera is a piece of furniture, referring to a database that stores information regarding images of a number of objects. The augmented remote controller may search for information about the furniture, such as name or manufacturer of the furniture, and display the determined information to the user.

The augmented remote controller may augment a real image captured by the camera with determined information regarding an object captured by the camera. For example, the augmented remote controller may display a real image captured by the camera on a display, search for information regarding an object included in the displayed real image, and display the detected or determined information regarding the object on the display using a pop-up window or an icon. Additionally, the augmented remote controller may display the detected or determined information regarding the object as an image or as text on the display.

The user may view the real image augmented with the information detected by the augmented remote controller, through the augmented remote controller. The user may identify information regarding the real image or an object included in the real image by the augmented information overlaid on the real image captured by the camera.

If the display that displays the augmented real image is a touch screen, the user may interact with the augmented remote controller by selecting a pop-up window, an icon, an image, and/or text representing the augmented information. For example, when the user selects a pop-up window representing first augmented information, the augmented remote controller may execute an application related to the first augmented information. The application may be an application that controls an object such as an image display apparatus or an external device included in the augmented real image.

If the augmented remote controller uses a transparent display, the augmented remote controller may display augmented information overlaid on a real image projected onto the transparent display. The augmented remote controller may search for information regarding an object included in the displayed real image and display the determined information as augmented information on the transparent display.

The augmented remote controller may wirelessly transmit signals to and receive signals from an image display apparatus or an external device connectable to the image display apparatus. The user may control the image display apparatus or the external device by using the augmented remote controller. The augmented remote controller may receive information regarding operation status of the image display apparatus or the external device and display the received information on the display.

The augmented remote controller may be connected to a network including the Internet. The augmented remote controller may search for information regarding an identified object through the network and display the determined information on the display.

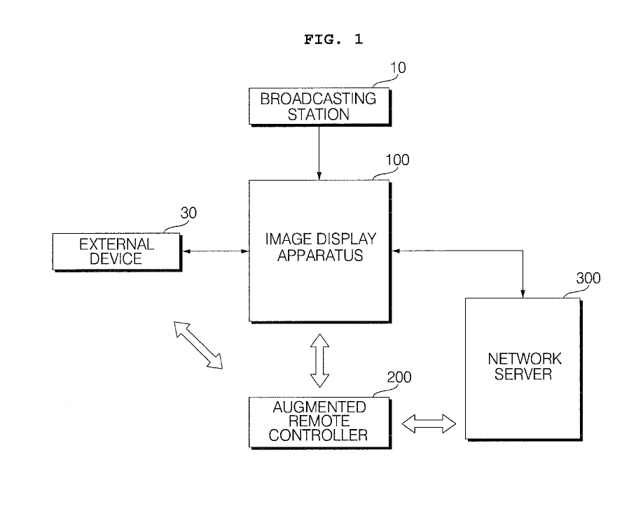

FIG. 1 is a block diagram of an augmented remote control system according to an exemplary embodiment of the present invention.

As shown in FIG. 1, an augmented remote controller 200 may transmit signals to and receive signals from an image display apparatus 100, an external device 30 connectable to the image display apparatus 100, and a network server 300. The image display apparatus 100 can play various kinds of contents. The image display apparatus 100 may receive an external signal including a video signal corresponding to a content. The image display apparatus 100 may extract the video signal from the received signal and display an image corresponding to the extracted video signal.

The external device 30 can play back contents that are stored in compliance with a predetermined standard. The external device 30 may include a display. The external device 30 may display an image corresponding to a played content on the display. The external device 30 may be connected to the image display apparatus 100 and may transmit a signal including a video signal corresponding to a content to the image display apparatus 100. The image display apparatus 100 may display an image corresponding to the video signal included in the received signal.

The image display apparatus 100 may receive a broadcast signal from a broadcasting station 10 and may display an image corresponding to a video signal included in the broadcast signal. The image display apparatus 100 may also receive a signal including a video signal from the network server 300 over the network including the Internet and display an image corresponding to the video signal included in the received signal.

When the image display apparatus 100 is connected to the Internet, the image display apparatus 100 may receive a signal including a video signal corresponding to a specific content from a content provider on the Internet to provide content over the Internet and display an image corresponding to the video signal. The content provider may transmit the video signal to the image display apparatus 100 through the network server 300.

The augmented remote controller 200 may identify or determine the image display apparatus 100 or the external device 30. More specifically, the augmented remote controller 200 may identify or determine the image display apparatus 100 or the external device 30 by capturing an image of a real environment of a user and analyzing the captured image. If an RFID tag is attached to the image display apparatus 100 or the external device 30, the augmented remote controller 200 may receive a signal from the image display apparatus 100 or the external device 30 through an RFID reader and identify (or determine) the image display apparatus 100 or the external device 30 based on the received signal.

The augmented remote controller 200 may identify or determine the image display apparatus 100 or the external device 30 by transmitting and receiving another type of signals to and from the image display apparatus 100 or the external device 30. For example, the augmented remote controller 200 may transmit and receive InfraRed (IR) or Radio Frequency (RF) signals to and from the image display apparatus 100 or the external device 30. The augmented remote controller 200 may be paired with the image display apparatus 100 or the external device 30, which transmits and receives IR or RF signals. The image display apparatus 100 or the external device 30 may identify or determine a signal received from the paired augmented remote controller 200.

The augmented remote controller 200 may display menus for controlling the identified image display apparatus 100 or the external device 30 on the display of the augmented remote controller 200. The user may enter a command to control the image display apparatus 100 or the external device 30 by selecting a menu on the display or manipulating a button or key of the augmented remote controller 200. The augmented remote controller 200 may transmit a signal carrying the user-input command to the image display apparatus 100 or the external device 30. The image display apparatus 100 or the external device 30 may be controlled by the signal transmitted from the augmented remote controller 200.

The augmented remote controller 200 may identify the image display apparatus 100 or the external device 30 by use of a camera, an RFID reader, etc. The augmented remote controller 200 may identify information related to contents provided by the identified image display apparatus 100 or the external device 30 from metadata received from the image display apparatus 100 or the external device 30. Further, the augmented remote controller 200 may search the network server 300 for the information related to the contents provided by the image display apparatus 100 or the external device 30.

The augmented remote controller 200 may display the content-related information on its display. The type of the content-related information may correspond to type of the contents identified by the augmented remote controller 200.

For example, when a shopping-related content is currently provided, the augmented remote controller 200 may detect information about price of an item, name of a product, a store that sells the product, and/or an on-line shopping site in association with the shopping-related content in metadata or the Internet. When a content related to a famous tourist spot is currently provided, the augmented remote controller 200 may detect content-related information, such as name of the tourist spot, souvenirs, photos or videos of the tourist spot, etc., in metadata or the Internet. When the current content is a movie, the augmented remote controller 200 may detect information about producer, production company, and cast of the movie and other movie-related information in metadata or the Internet. The user may set types of information that the augmented remote controller 200 is to search for based on content types.

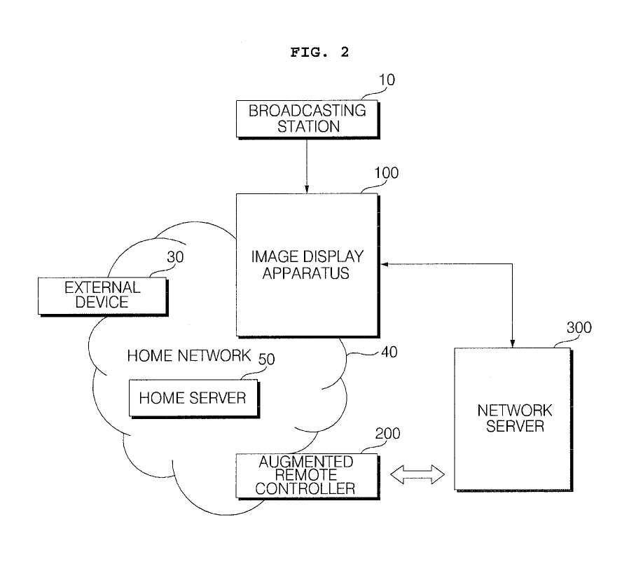

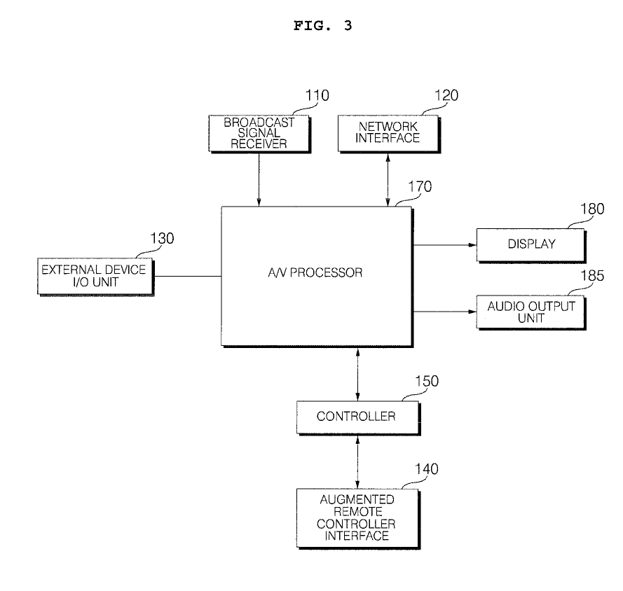

FIG. 2 is a block diagram of an augmented remote control system according to an exemplary embodiment of the present invention.

The augmented remote controller 200 may directly transmit signals to or receive signals from the image display apparatus 100 and the external device 30. Alternatively or additionally, the augmented remote controller 200 may transmit signals to or receive signals from a home server 50 of a home network 40 connected to the image display apparatus 100 or the external device 30. The home network 40 is a network in which a predetermined number of image display apparatuses 100 or external devices 30 may transmit signals to or receive signals from according to a predetermined network communication standard. The home network 40 may be independent of the network in which the network server 300 including the content provider is built. The home network 40 may be configured in an office or a home, for example.

The home server 50 may store information regarding the image display apparatus 100 and the external network 30 connected to the home network 40. For example, the home server 50 may store information regarding product name, model name, use guide, and available contents of the image display apparatus 100 or the external network 30 connected to the home network 40. The home server 50 may also control signal transmission and reception to and from the home network 40.

The augmented remote controller 200 may identify or determine a type of the image display apparatus 100 or the external network 30 connected to the home network 40 by camera, RFID reader, etc. The augmented remote controller 200 may receive information regarding the image display apparatus 100, information regarding the external device 30, and/or information regarding contents available from the image display apparatus 100 or the external device 30, directly from the image display apparatus 100 or the external device 30, through the home server 50, and/or through the network server 300.

The augmented remote controller 200 may display the detected (or determined) information on its display. Augmented information may be overlaid on an image captured by the camera or a real image projected on the transparent display. The augmented remote controller 200 may display the augmented real image overlapped with the augmented information on the display.

The augmented remote controller 200 may receive object-related information from the home server 50. For example, the home server 50 may store information regarding contents played in the image display apparatus 100 or the external device 30. Thus, the augmented remote controller 200 may receive, from the home server 50, information (e.g. a content title, a play time, etc.) regarding a content being played in an object (e.g. the image display apparatus 100 or the external device 30) identified (or determined) by the augmented remote controller 200, and/or information related to the content (e.g. information regarding items or places appearing in the content).

FIG. 3 is a block diagram of an image display apparatus according to an exemplary embodiment of the present invention.

As shown in FIG. 3, the image display apparatus 100 may include a broadcast signal receiver 110, a network interface 120, an external device Input/Output (I/O) unit 130, a remote controller interface 140 (or augmented remote controller interface), a controller 150, an A/V processor 170, a display 180, and an audio output unit 185.

The broadcast signal receiver 110 may select an RF broadcast signal corresponding to a channel selected by a user from among a plurality of RF broadcast signals received through an antenna or an RF broadcast signal corresponding to each of pre-memorized channels, and downconvert the RF broadcast signal to a digital Intermediate Frequency (IF) signal or an analog baseband A/V signal.

The broadcast signal receiver 110 may receive RF broadcast signals from an Advanced Television Systems Committee (ATSC) single-carrier system and/or from a Digital Video Broadcasting (DVB) multi-carrier system.

The broadcast signal receiver 110 may sequentially select RF broadcast signals corresponding to all broadcast channels previously memorized in the image display apparatus 100 by a channel-add function from among a plurality of RF signals received through the antenna, and may downconvert the selected RF broadcast signals to IF signals or baseband A/V signals. This operation may be performed to display a thumbnail list that includes a plurality of thumbnail images corresponding to broadcast channels on the display 180. Accordingly, the broadcast signal receiver 110 may receive the RF broadcast signal of the selected channel, and/or may receive the RF broadcast signals of all of the pre-memorized channels sequentially or periodically.

The network interface 120 may interface between the image display apparatus 100 and a wired/wireless network such as the Internet.

The network interface 120 may include a wireless communication module for connecting the image display apparatus 100 wirelessly to the Internet. For wireless Internet connection, the network interface 120 may operate in conformance with communication standards such as Wireless Local Area Network (WLAN) (i.e. Wi-Fi), Wireless Broadband (WiBro), World Interoperability for Microwave Access (WiMax), and/or High Speed Downlink Packet Access (HSDPA).

The network interface 120 may receive contents or data from a content provider or a network provider over a network. The received contents or data may include contents such as movies, advertisements, games, Video-on-Demand (VoD) files, and broadcast signals, and information related to the contents. The network interface 120 may also receive update information and update files of firmware from the network operator.

The external device I/O unit 130 may interface between the external device 30 and the image display apparatus 100. For interfacing, the external device I/O unit 130 may include an A/V I/O unit (not shown) and/or a wireless communication module (not shown).

The external device I/O unit 130 may be connected wirelessly or wiredly to the external device 30, such as a Digital Versatile Disc (DVD), a Blu-ray disc, a game player, a camera, a camcorder, and/or a computer (e.g. a laptop computer). The external device I/O unit 130 may receive video, audio, and/or data signals from the connected external device 30 and transmit the received external input signals to the A/V processor 170. Additionally, the external device I/O unit 130 may output video, audio, and/or data signals processed by the A/V processor 170 to the connected external device 30.

To provide video and audio signals received from the external device 30 to the image display apparatus 100, the A/V I/O unit of the external device I/O unit 130 may include an Ethernet port, a Universal Serial Bus (USB) port, a Composite Video Banking Sync (CVBS) port, a component port, a Super-video (S-video) (analog) port, a Digital Visual Interface (DVI) port, a High-Definition Multimedia Interface (HDMI) port, a Red-Green-Blue (RGB) port, and/or a D-sub port.

The wireless communication module of the external device I/O unit 130 may perform short-range wireless communication with other external devices. For short-range wireless communication over a network, the wireless communication module may operate in compliance with communication standards such as Bluetooth, RFID, InfraRed Data Association (IrDA), Ultra WideBand (UWB), and/or ZigBee.

The external device I/O unit 130 may be connected to various set-top boxes through at least one of the Ethernet port, the USB port, the CVBS port, the component port, the S-video port, the DVI port, the HDMI port, the RGB port, and the D-sub port and may thus receive data from or transmit data to the various set-top boxes.

For example, in an Internet Protocol TV (IPTV) set-top box, the external device I/O unit 130 may provide video, audio and/or data signals received from the IPTV set-top box to the A/V processor 170 and provide signals processed by the A/V processor 170 to the IPTV set-top box in order to enable interactive communication.

Depending on types of transmission networks, the term “IPTV” may refer to Asynchronous Digital Subscriber Line-TV (ADSL-TV), Very high data rate Digital Subscriber Line-TV (VDSL-TV), Fiber To The Home-TV (FTTH-TV), TV over DSL, Video over DSL, TV over IP (TVIP), Broadband TV (BTV), etc. Additionally, the term “IPTV” may cover Internet TV and full browsing TV.

The external device I/O unit 130 may be connected to a communication network that enables voice calls or video calls. The communication network may be any one of a broadcasting communication network connected by a LAN, a Public Switched Telephone Network (PSTN), and/or a mobile communication network.

The augmented remote controller interface 140 may include a wireless communication module (not shown) for wirelessly transmitting signals to and receiving signals from the augmented remote controller 200, and a coordinate calculator (not shown) for calculating coordinates of a target position to which a pointer should be moved in correspondence with movement of the augmented remote controller 200.

The augmented remote controller interface 140 may wirelessly transmit and receive signals to and from the augmented remote controller 200 through an RF module. The augmented remote controller interface 140 may also wirelessly receive signals from the augmented remote controller 200 through an IR module according to an IR communication standard.

The coordinate calculator of the augmented remote controller interface 140 may correct handshakes or errors in the signal corresponding to movement of the augmented remote controller 200 received through the wireless communication module of the augmented remote controller interface 140. After correcting handshakes or errors, the coordinate calculator may calculate x and y coordinates of the target position at which the pointer should be displayed on the display 180.

The controller 150 may identify a movement or key manipulation of the augmented remote controller 200 from a signal received from the augmented remote controller 200 through the augmented remote controller interface 140 and thus may control an operation of the image display apparatus 100 based on the identified movement or key manipulation.

In another example, the augmented remote controller 200 may calculate coordinates of a target position to which the pointer should be moved in correspondence with movement of the augmented remote controller 200 and may output the calculated coordinates to the augmented remote controller interface 140. The augmented remote controller interface 140 may transmit information regarding the received pointer coordinates to the controller 150 without correcting handshakes or errors.

The controller 150 may provide overall control to the image display apparatus 100. The controller 150 may receive a signal from the augmented remote controller 200 through the augmented remote controller interface 140. The controller 150 may also receive a command through a local key of the image display apparatus 100. Thus, the controller 150 may identify a command included in the received signal or the command corresponding to the manipulated local key, and thus control the image display apparatus 100 based on the command.

For example, upon receipt of a command to select a particular channel from the user, the controller 150 may control the broadcast signal receiver 110 to receive a broadcast signal of the selected channel. The controller 150 may control the A/V processor 170 to process a video or audio signal of the selected channel. The controller 150 may also control the A/V processor 170 to output information regarding the selected channel along with the processed video or audio signal to the display 180 or the audio output unit 185.

In another example, the user may enter another type of A/V output command through the augmented remote controller 200. That is, the user may want to view a video signal input from a camera or a camcorder through the external device I/O unit 130, rather than a broadcast signal. In this example, the controller 150 may control the A/V processor 170 to output an audio or video signal received through the USB port of the external device I/O unit 130 to the audio output unit 185 or the display 180.

The image display apparatus 100 may further include a user interface controller for generating a Graphic User Interface (GUI) related to the image display apparatus 100. The controller 150 may perform a function of the user interface controller. In an exemplary embodiment, the user interface controller may be described as a separate component.

A GUI created by the user interface controller may be output to the display 180 or the audio output unit 185 through the A/V processor 170. The GUI may change according to a command included in a signal received from the augmented remote controller 200, a command received through a local key of the image display apparatus 100, and/or an operation of the image display apparatus 100.

For example, upon receipt of a signal from the augmented remote controller 200, the user interface controller may generate a pointer image signal corresponding to movement of the augmented remote controller 200 and output the pointer image signal to the A/V processor 100. The controller 150 may output information regarding coordinates of a target position to which the pointer should be moved, calculated from the signal received from the augmented remote controller 200, to the user interface controller. The user interface controller may generate the pointer image signal based on the received coordinate information. The A/V processor 170 may perform signal processing such that the pointer corresponding to the pointer image signal created by the user interface controller is displayed on the display 180. The pointer displayed on the display 180 may correspond to movement of the augmented remote controller 200.

In another example, the user interface controller may generate a user interface image signal including an object corresponding to a command included in a signal received from the augmented remote controller 200, a command input by a local key, and/or an operation of the image display apparatus 100 and output the user interface image signal to the A/V processor 170.

The object may include a widget that is displayed on the display 180 to enter a command to the image display apparatus 100 and/or to represent information related to the image display apparatus 100. The widget may be displayed in On Screen Display (OSD).

The object may be selectable, meaning that additional information exists if selected. Types of objects may include a device object, a content object and a menu object, for example.

The object may be displayed as an image or text that represents information regarding the image display apparatus 100 or as an image or text representing an image displayed on the image display apparatus 100, such as a volume level, channel information, a current time, etc. The object may be realized as any other form (e.g. a moving picture) according to type of information that can be or should be displayed on the image display apparatus 100. Objects according to the exemplary embodiments should not be construed as limiting the scope and spirit of the present invention.

A widget is an element by which the user can change particular data on his own or her own on a GUI. For example, a widget may be one of a volume control button, a channel selection button, a menu, an icon, a navigation tab, a scroll bar, a progress bar, a text box, and a window, which are displayed on the display 180. The form of a widget realized in the image display apparatus 100 may vary with the specification of a GUI that can be implemented or should be implemented in the image display apparatus 100. Widgets according to exemplary embodiments do not limit the present invention.

The A/V processor 170 may process an audio signal and/or a video signal included in a signal received through the broadcast signal receiver 110, the network interface 120, and/or the external device I/O unit 130 to be suitable for the display 180. The A/V processor 170 may process the audio signal and/or the video signal based on information carried by a data signal received along with the audio signal and/or the video signal.

The A/V processor 170 may process an audio signal and/or the video signal received through the user interface controller so that the audio signal and/or the video signal is output through the display 180 and/or the audio output unit 185. The user may identify an operation status of the image display apparatus 100 or enter a command related to the image display apparatus 100 on a GUI displayed on the display 180 according to the audio signal and/or the video signal generated from the user interface controller.

The A/V processor 170 may select an audio signal and/or a video signal to be processed based on a user command received through the controller 150. The audio signal and/or the video signal processed by the A/V processor 170 may be output through the audio output unit 185 and/or the display 180. The user command may be a broadcast channel selection command, a command to select a content to be played from among content input to the image display apparatus 100, and/or the like.

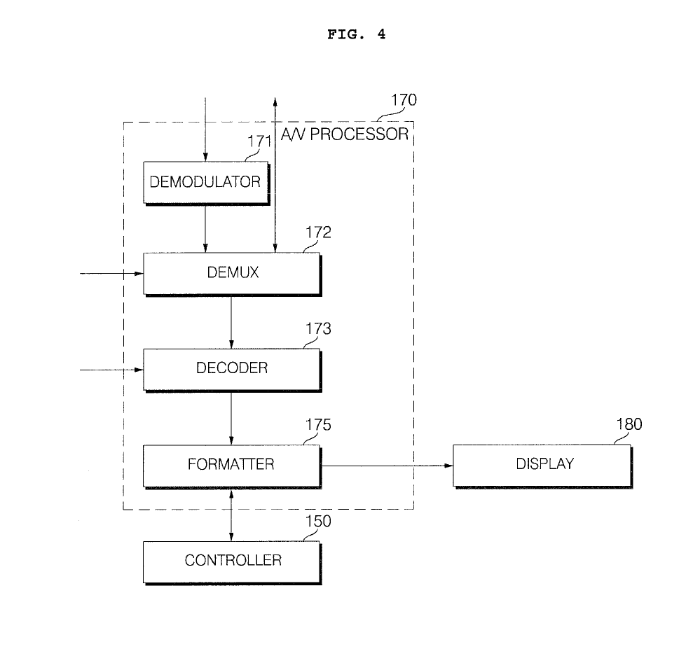

In accordance with an exemplary embodiment, the A/V processor 170 may process a video signal so that an external input two-dimensional (2D) or three-dimensional (3D) video signal may be displayed on the display 180. The A/V processor 170 may process a video signal such that a user interface created by the user interface controller may be displayed in 3D on the display 180. The A/V processor 170 may be described below in great detail with reference to FIG. 4.

The display 180 may generate a driving signal by converting a video signal, a data signal, and/or an OSD signal processed by the A/V processor 170, or video signal and/or a data signal received through the external device I/O unit to an RGB signal. The display 180 may be any one of various types of displays such as a Plasma Display Panel (PDP), a Liquid Crystal Display (LCD), an Organic Light Emitting Diode (OLED), and/or a flexible display. According to an exemplary embodiment, the display 180 may be capable of displaying 3D images.

For 3D visualization, the display 180 may be configured into an auto-stereoscopic 3D display (glasses-free) and/or a traditional stereoscopic 3D display (with glasses).

Auto-stereoscopy is a method of displaying 3D images without any auxiliary device, for example, special polarization glasses on the part of a user. Thus, the display 180 may display 3D images on its own. Renticular and parallax barrier are examples of auto-stereoscopic 3D imaging.

The traditional stereoscopy may require an auxiliary device besides the display 180 in order to display 3D images. The auxiliary device may be a Head Mount Display (HMD) type, a glasses type, etc. As special 3D glasses, there are polarization glasses, shutter glasses, and a spectrum filter.

The display 180 may also be implemented as a touch screen so that it is used not only as an output device but also as an input device.

The audio output unit 185 may receive a processed audio signal (e.g. a stereo signal, a 3.1-channel signal or a 5.1-channel signal) from the A/V processor 170 and output the received audio signal as voice. The audio output unit 185 may hp implemented as various types of speakers.

FIG. 4 is a block diagram of an A/V processor in an image display apparatus according to an exemplary embodiment of the present invention.

As shown in FIG. 4, the A/V processor 170 may include a demodulator 171, a Demultiplexer (DEMUX) 172, a decoder 173, and a formatter 175.

The demodulator 171 may demodulate a broadcast signal received from the broadcast signal receiver 110. For example, the demodulator 171 may receive a digital IF signal DIF from the broadcast signal receiver 110 and demodulate the digital IF signal DIF. The demodulator 171 may also perform channel decoding. For channel decoding, the demodulator 171 may include a convolutional decoder (not shown), a deinterleaver (not shown) and a Reed-Solomon decoder (not shown) and perform convolutional decoding, de-interleaving and Reed-Solomon decoding.

The demodulator 171 may perform demodulation and channel decoding on the digital IF signal received from the broadcast signal receiver 110, thereby obtaining a stream signal TS. The stream signal TS may be a signal in which a video signal, an audio signal and/or a data signal are multiplexed. For example, the stream signal TS may be an Moving Picture Experts Group-2 (MPEG-2) Transport Stream (TS) signal obtained by multiplexing an MPEG-2 video signal and a Dolby AC-3 audio signal. The MPEG-2 TS signal may include a 4-byte header and a 184-byte payload.

In order to properly handle not only ATSC signals but also DVB signals, the demodulator 171 may include an ATSC demodulator and a DVB demodulator. The demodulator 171 may output the stream signal TS to the DEMUX 172.

The DEMUX 172 may demultiplex the stream signal TS, for example, an MPEG-2 TS into an audio signal, a video signal, and a data signal. The DEMUX 172 may receive the stream signal from the demodulator 171, the network interface 120, and/or the external device I/O unit 130.

The data signal obtained by demultiplexing the input stream signal may be a coded data signal. The coded data signal may include Electronic Program Guide (EPG) information that provides broadcasting information such as titles and start and end times of broadcast programs played on each broadcast channel. For example, the EPG information may be ATSC-Program and System Information Protocol (TSC-PSIP) information in case of ATSC, whereas it may be DVB-Service Information (DVB-SI) in case of DVB.

The decoder 173 may decode the demultiplexed signals. In this exemplary embodiment, the decoder 173 may include a video decoder for decoding the demultiplexed video signal, and a scaler for controlling resolution of the decoded video signal to a resolution level at which the decoded video signal can be output in the image display apparatus 100.

In accordance with an exemplary embodiment, the A/V processor 170 may further include a mixer for mixing an external video signal input to the image display apparatus 100 with a video signal generated from the user interface controller. While the mixer may be incorporated into the formatter 175 in function, the mixer may be described herein as being separate from the formatter 175, for ease of convenience. The display 180 may display an image based on a mixed video signal. The mixer may output the mixed video signal to the formatter 175.

The formatter 175 may identify a format of the mixed video signal referring to a data signal related to the video signal. The formatter 175 may convert the video signal to a format suitable for the display 180 and output the converted video signal to the display 180.

In this exemplary embodiment, the image display apparatus 100 may display a 3D image on the display 180. The formatter 175 may create a 3D video signal in a predetermined format by separating the mixed video signal into multi-viewpoint image signals and may output the 3D video signal to the display 180. The display 180 may display a 3D image based on the 3D video signal.

A 3D image may be formed with multi-viewpoint images. The user may view the multi-viewpoint images with his or her left and right eyes. Disparity between the multi-viewpoint images viewed by the left and right eyes may provide the illusion of 3D to the user. The multi-viewpoint images that form the 3D image may be a left-eye image perceivable to the left eye and a right-eye image perceivable to the right eye.

The format of a 3D video signal may be determined according to the layout of the left-eye and right-eye images of the 3D video signal. The left-eye and right-eye images may be provided on the left and right sides, respectively. This may be called a side by side format. The left-eye and right-eye images may be arranged vertically in a top-down format. A time-division layout of the left-eye and right-eye images may be called a frame sequential format. The left-eye and right-eye images may alternate with each other line by line. This may be called an interlaced format. The left-eye and right-eye images may be mixed in the form of boxes in a checker box format.

A video signal included in an external signal input to the image display apparatus 100 and a GUI video signal created from the user interface controller may be 3D video signals with which 3D images are realized. The mixer may mix these 3D video signals and output the mixed 3D video signal to the formatter 175.

The formatter 175 may identify a format of the mixed 3D video signal referring to a related data signal. The formatter 175 may process the 3D video signal according to the identified format and output the processed 3D video signal to the display 180. If limited 3D image formats are available to the display 180, the formatter 175 may convert the received 3D video signal to a 3D image format in which the display 180 can display a 3D image and output the converted 3D video signal to the display 180.

If the formatter 175 fails to identify the format of the mixed video signal referring to the related data signal, it may use a predetermined algorithm to thereby identify the format. For example, the formatter 175 may identify the format of an input 3D video signal by analyzing edges of an image created based on the input 3D video signal.

If the input mixed video signal is a 2D video signal that allows 2D visualization, the formatter 175 may generate a 3D video signal using a 2D-3D conversion algorithm.

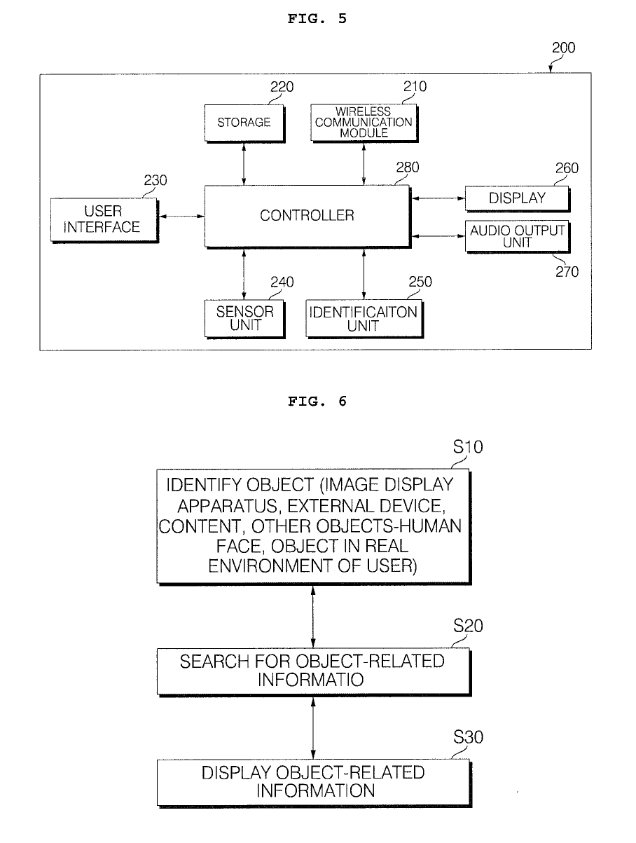

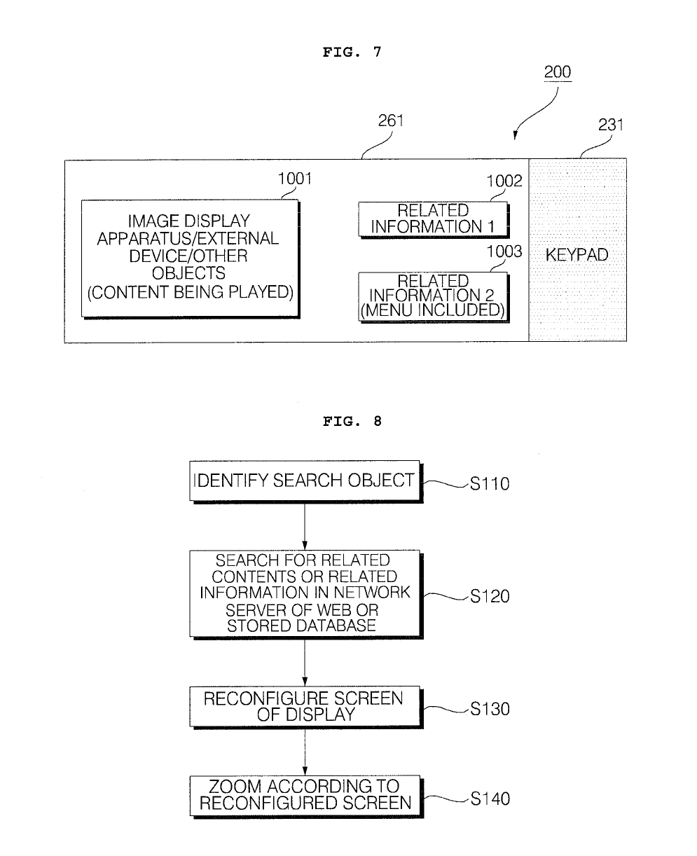

FIG. 5 is a block diagram of the augmented remote controller 200 according to an exemplary embodiment of the present invention. As discussed above, embodiments may also be applicable to other devices, such as pointing devices, goggles, or other devices with displays.

Referring to FIG. 5, the augmented remote controller 200 may include a wireless communication module 210, a storage 220 (or a memory), a user interface 230, a sensor unit 240, an identification unit 250, a display 260, an audio output unit 270, and a controller 280.

The wireless communication module 210 may transmit signals to and receive signals from electronic devices such as the image display apparatus 100, the external device 30, the home server 50, and/or the network server 300. The augmented remote controller 200 may further include an RF module for transmitting signals to and receiving signals from an adjacent device in compliance with an RF communication standard. The augmented remote controller 200 may also include an IR module for transmitting signals to and receiving signals from an adjacent device in compliance with an IR communication standard.

The augmented remote controller 200 may communicate with other electronic devices according to other various communication standards. Besides the wireless communication module 210, the augmented remote controller 200 may have a module suitable for signal transmission and reception based on a particular communication standard. The wireless communication module 210 may transmit and receive signals in Bluetooth, RFID, IrDA, UWB, and/or ZigBee, for example.

The wireless communication module 210 may transmit signals to and receive signals from the Internet by various wireless Internet standards and thus may be equipped with modules for signal transmission and reception based on particular wireless Internet standards. Wireless Internet standards available to the augmented remote controller 200 may include WLAN, WiBro, WiMax and/or HSDPA.

In an exemplary embodiment, the augmented remote controller 200 may transmit a signal carrying information regarding an operation of the augmented remote controller 200 to an electronic device through the wireless communication module 210. The augmented remote controller 200 may also receive a signal from the electronic device through the RF module. The augmented remote controller 200 may transmit commands such as a power on/off command, a channel change command, and/or a volume change command to the electronic device through the IR module.

The storage 220 (or memory) may store a number of programs and application data required for controlling or operating the augmented remote controller 200. If the augmented remote controller 200 wirelessly transmits signals to and receives signals from an electronic device through the RF module, the augmented remote controller 200 and the electronic device may exchange signals with each other in a predetermined frequency band. The controller 280 may store information regarding a frequency band in which the augmented remote controller 200 can wirelessly communicate with a paired adjacent device in the storage 220, and thus may later refer to the stored information.

The user interface 230 may include a keypad or a plurality of buttons. A user may enter commands to the image display apparatus 100 by manipulating the user interface 230. If the user interface 230 includes a plurality of hard-key buttons, the user may input various commands to the image display apparatus 100 by pressing the hard-key buttons. Alternatively or additionally, if the user interface 230 includes a touch screen displaying a plurality of soft keys, the user may input various commands to the image display apparatus 100 by touching the soft keys. The user interface 230 may also include various input tools other than those set forth herein, such as a scroll key and/or a jog key.

The sensor unit 240 may include sensors for collecting information regarding a user that uses the augmented remote controller 200. The sensor unit 240 may include a GPS, a compass, a gyro sensor, an acceleration sensor, and/or an IR sensor. The GPS may be used to locate the user and the compass may be used to determine the bearing of the user. The gyro sensor may sense movement of the augmented remote controller 200, for example, in X-, Y-, and Z-axis directions, and the acceleration sensor may sense a moving speed of the augmented remote controller 200.

The augmented remote controller 200 may identify or determine an object around (or about) the user, referring to the user-related information collected by the sensor unit 240. The augmented remote controller 200 may also identify or determine a user's gesture, referring to the collected user-related information. The augmented remote controller 200 may be controlled based on a command corresponding to the user's gesture. If the command corresponding to the user's gesture is a command to control an electronic device, the augmented remote controller 200 may transmit a signal carrying the control command to the electronic device.

The identification unit 250 may identify an object around (or about) the user, such as an electronic device. The identification unit 250 may include a camera, an RFID reader, an IR sensor, etc. The identification unit 250 may capture an image of the object using the camera. The captured image of the object may be compared with images of various objects stored in the storage 220, the home server 50, and/or the network server 300. The identification unit 250 may analyze a pattern of the image and extract information regarding an object corresponding to an image with a pattern matching the pattern of the captured image, thereby identifying the object.

The identification unit 250 may also identify an object by reading an RFID tag attached to the object using the RFID reader. Alternatively or additionally, the identification unit 250 may determine presence or absence of any object around the user using the IR sensor. The augmented remote controller 200 may refer to information regarding objects matching user positions or bearings. The information regarding the objects matching the user positions or bearings may be stored in the storage 220, the home server 50, and/or the network server 300.

The identification unit 250 may identify a current location and bearing of user based on the user-related information collected by the sensor unit 240 and may extract information regarding an object whose presence was sensed by the IR sensor, corresponding to the user location and bearing, from the stored information regarding objects, thus identifying or determining the object around the user. For example, the augmented remote controller 200 may refer to map information including information regarding buildings corresponding to user locations and bearings. In this example, the augmented remote controller 200 may identify or determine a building around the user, referring to information regarding objects corresponding to the location and bearing of the user that is carrying the augmented remote controller 200 in the map information.

The identification unit 250 may also identify the face, finger print, and/or iris of a person captured by the camera. The identification unit 250 may identify the person by comparing the pattern of the identified face, finger print, and/or iris with stored patterns of faces, finger prints, and/or irises. The controller 280 may search for information regarding an object identified by the identification unit 250. For example, if the identification unit 250 identifies a person, the controller 280 may search for information regarding the person, such as name, age, and preferred contents of the person and output the detected information.

The audio I/O unit 270 may recognize a voice signal from a user.

The display 260 and the audio output unit 270 may output an image and a sound corresponding to a manipulation of the user interface 230 or a signal received from an electronic device, such as the image display apparatus 100, the external device 30, the home server 50, and/or the network server 300. Thus, the user may determine from the display 260 and the audio output unit 270 whether the user interface 730 has been manipulated or the electronic device has been controlled.

The audio I/O unit may be configured separately as an audio input unit and an audio output in an exemplary embodiment.

The display 260 may display information regarding an object included in an image captured by the camera. The display 260 may display an augmented real image obtained by superimposing detected augmented information on the captured image. In another example, if the display 260 is implemented in a transparent display with a transparent panel, the user may view a real image of his or her environment on the transparent display 260. The augmented remote controller 200 may search for information regarding an object included in the real image displayed on the transparent display 260 and thus may display the determined object-related information on the transparent display 260.

The controller 280 may superimpose the augmented information on the captured image and may thus output the augmented real image to the display 260. The controller 280 may output an augmented information-related video signal to the display 260 so that the augmented information regarding the object included in the real image projected onto the transparent display 260 may be superimposed on the real image. The controller 280 may provide overall control to the augmented remote controller 200.

The controller 280 may transmit a signal corresponding to a manipulation of a particular key of the user interface 230 or a signal corresponding to an operation of the augmented remote controller 200 sensed by the sensor unit 240 to an electronic device through the wireless communication module 210.

The block diagrams of the image display apparatus 100 and the augmented remote controller 200 shown in FIGS. 3, 4 and 5 are exemplary embodiments. Depending on specifications of the image display apparatus 100 and the augmented remote controller 200 in real implementation, some components of the image display apparatus 100 and the augmented remote controller 200 may be incorporated or omitted, and/or new components may added to the image display apparatus 100 and the augmented remote controller 200. That is, two or more components may be incorporated into one component or one component may be configured as separate components, when needed. Additionally, a function of each block is described for the purpose of describing exemplary embodiments and thus specific operations or devices should not be construed as limiting the scope and spirit of the present invention.

FIG. 6 is a flowchart illustrating a method for operating the augmented remote controller 200 according to an exemplary embodiment of the present invention. Other operations, orders of operations and embodiments are also within the scope of present invention.

As shown in FIG. 6, the augmented remote controller 200 may identify or determine an object around a user (or about a user) in operation S10, search for information related to the identified object in operation S20, and display the determined object-related information in operation S30.

The augmented remote controller 200 may identify or determine various types of objects around the user. The user may select an intended type of objects by using the augmented remote controller 200. For example, the user may select an electronic device so that the augmented remote controller 200 may identify or determine the electronic device. The augmented remote controller 200 may identify the electronic device around the user using an RFID tag attached to the electronic device.

The user may select content available from the image display apparatus 100 or the external device 200 as objects to be identified (or determined). The augmented remote controller 200 may identify or determine a content provided by the image display apparatus 100 or the external device 200 using metadata received from the image display apparatus 100, the external device 30, and/or the home server 50. That is, if an identification device such as the camera or the RFID reader provided in the augmented remote controller 200 points to the image display apparatus 100, the augmented remote controller 200 may identify or determine the image display apparatus 100 playing a content that the user wants to be identified and the augmented remote controller 200 may then identify the content being played in the image display apparatus 100 by using metadata related to the image display apparatus 100.

Additionally, the user may select a person for identification. In this example, the augmented remote controller 200 may read the face, the finger print, and/or the iris of the person by use of the camera, a finger print identifier, and/or an iris identifier in the identification unit 250. The augmented remote controller 200 may identify the person by comparing the read information with information regarding the faces, the finger prints, and/or the irises of persons stored in a database.

The augmented remote controller 200 may also recognize a person from a voice input of the person.

The user may also select an object around him or her (e.g. a building, furniture, etc.). In this example, the augmented remote controller 200 may collect information regarding location or bearing of the user by GPS or compass. The augmented remote controller 200 may also capture an image of the object using the camera and identify the captured object, referring to image information regarding objects corresponding to the current user location or bearing in the database that stores information regarding objects by user location and bearing.

Information that the augmented remote controller 200 refers to for identifying an object may be stored in the image display apparatus 100, the external device 30, the storage 220 of the augmented remote controller 200, the home server 50, and/or the network server 300. Thus, the augmented remote controller 200 may search for information regarding an identified object in the image display apparatus 100, the external device 30, the storage 220 of the augmented remote controller 200, the home server 50, and/or the network server 300.

For example, when the augmented remote controller 200 identifies or determines the image display apparatus 100 or the external device 30, the augmented remote controller 200 may search for a list of contents being played in the image display apparatus 100 or the external device 30. The augmented remote controller 200 may also search for a list of contents stored in the image display apparatus 100 or the external device 30. Additionally, the augmented remote controller 200 may search for information regarding a broadcast signal received at the image display apparatus 100. The augmented remote controller 200 may also search for information including menus with which to control the image display apparatus 100 or the external device 30.

When the augmented remote controller 200 identifies or determines a content being played or stored in the image display apparatus 100 or the external device 30, the augmented remote controller 200 may search for information related to the content. The content-related information may be a title of the content, shopping information for the content, etc.

If the augmented remote controller 200 identifies or determines a person, the augmented remote controller 200 may search for information regarding the person. The person-related information may specify a name, a age, a job and/or a phone number of the person, contents that the person prefers, and/or a history of contents that the person has viewed.

If the augmented remote controller 200 identifies or determines a real object around the user (e.g. a building, furniture, etc.), the augmented remote controller 200 may search for information related to the object. The object-related information may specify a name, a manufacturer, a price, a store, and/or a use guide of the object.

The augmented remote controller 200 may display the detected information on the display 260. The detected information may be displayed in a pop-up window or as an icon. The detected information may be displayed as an image or as text. The augmented remote controller 200 may display the detected augmented information superimposed on an image captured by the camera.

The controller 280 may configure a screen of the display 260 that detected information does not overlap with an object corresponding to the detected information from among the objects included in the real environment of the user. When displaying augmented information on the transparent display, the controller 280 may also configure a screen of the display 260 such that the augmented information is displayed without overlapping with an object corresponding to the augmented information.

FIG. 7 illustrates an exterior of the augmented remote controller 200 according to an exemplary embodiment of the present invention.

As shown in FIG. 7, a screen 261 displayed on the display 260 of the augmented remote controller 200 may include an object 1001 identified by the augmented remote controller 200 and object-related information 1002 and 1002, which is information related to the identified object 1011.

In this exemplary embodiment, the object 1001 identified by the augmented remote controller 200 is a real image of an object captured by the camera of the augmented remote controller 200. The object-related information 1002 and 1003 is augmented information including information detected by the augmented remote controller 200. As shown in FIG. 7, the augmented remote controller 200 may display the augmented information together with the real image of the object on the screen 261. The user may identify or determine information related to the captured object from the augmented information included in the screen 261.

The object-related information may include a menu for controlling the object. In the exemplary embodiment, the second object-related information 1003 (related information 2) may be a menu by which a related command is input to the image display apparatus 100 or the external device 30. The related information 2 may also be a menu by which the current playback of a content is discontinued or the content is transmitted to another electronic device.

When the screen 261 is displayed on a touch screen, the user may select the object-related information 1002 and 1003 on the screen 261 by touching the touch screen. Additionally, the user may enter a command corresponding to a particular icon to the augmented remote controller 200 by selecting the icon in the menu included in related information 2 displayed on the screen 261.

The augmented remote controller 200 may include a keypad 231. The user may enter a particular command to the augmented remote controller 200 by manipulating a predetermined key of the keypad 231.

FIG. 8 is a flowchart illustrating a method for operating an augmented remote controller and an augmented remote control system according to an exemplary embodiment of the present invention. Other operations, orders of operations and embodiments are also within the scope of the present invention.

As shown in FIG. 8, the augmented remote controller may identify or determine a search object in operation S110 and may search for information related to the search object in operation S120. The augmented remote controller may display an augmented real image on the display by reconfiguring a screen displayed on the display according to the detected information in operation S130. The augmented real image may be enlarged or contracted based on the amount of the determined (or detected) information in operation S140.

The search object identified by the augmented remote controller may be a keyword input to the augmented remote controller. For example, a user may enter a keyword to the augmented remote controller by using a keyboard. The keyboard may be a virtual keyboard displayed on the display of the augmented remote controller. When the augmented remote controller has a touch screen, the user may write the keyword on the touch screen.

The augmented remote controller may search for information related to the keyword in the image display apparatus, the external device, the home server, and/or the network server. The augmented remote controller may display search results for the keyword on its display. During the search, an icon indicating that the search is in progress may be displayed on the display of the augmented remote controller.

The augmented remote controller may search for contents matching the keyword from among contents stored in the external device. In an augmented remote control system with first and second external devices, the augmented remote controller may search for contents matching the keyword from among contents stored in each external device. The augmented remote controller may display information regarding the determined contents on the display of the augmented remote controller.

When the user points an identification device (such as a camera or an RFID reader) of the augmented remote controller at the first external device, the augmented remote controller may display an image of the first external device and an augmented real image with information regarding content matching the keyword in the first external device on the display of the augmented remote controller. Therefore, the user may search for content stored in a plurality of external devices in the augmented remote control system at one time and may view the search results.

In another example, the search object of the augmented remote controller may be content being displayed on the image display apparatus or an object included in the content. The object may be an actor/actress, an item, and/or the like. When the user keeps pointing the camera of the augmented remote controller at the image display apparatus for a predetermined time or longer, the augmented remote controller may receive metadata related to the object of the content. The augmented remote controller may receive the metadata related to the object from the image display apparatus or the home server.

The augmented remote controller may search for information, in the metadata, regarding the object of the content being displayed on the image display apparatus. For example, when the object is an actor appearing in the content, the augmented remote controller may detect information regarding the actor such as name, latest news, blog, and/or other contents of the actor. The augmented remote controller may configure a screen displayed on its display so as to make the determined augmented information appear beside the actor.

In another example, the search object of the augmented remote controller may be a real object around or about the user, captured by the camera or read by the RFID reader in the augmented remote controller. For example, the user may capture an image of a pencil using the augmented remote controller. The augmented remote controller may search for information regarding the object of the captured image in the home server or network server that stores images of various kinds of objects. The augmented remote controller may search for information regarding the pencil, such as how to use a pencil or how a pencil is called in English or Japanese. The augmented remote controller may display the detected (or determined) information on its display.

In another example, when a game is being played in the image display apparatus, an instruction prompting the user to find a real object around the user may be displayed on the display of the image display apparatus. The user may capture an image of a found real object by the augmented remote controller according to the mission indicated on the display of the image display apparatus. The augmented remote controller may compare the captured image with an image of the real object that the image display apparatus instructs the user to find. When the two images match, the augmented remote controller may increase a game score displayed on the display of the image display apparatus. Additionally, the augmented remote controller may display information regarding name or use guide of the real object on its display, thus providing educational effects.

In another example, the user may change an image displayed on the image display apparatus using the augmented remote controller. More specifically, the user may capture a picture or photo with a color and a shape appealing to the user using the augmented remote controller and transfer the captured picture or photo to the image display apparatus. A background image of the picture or photo may overlap with a background of an image being displayed on the image display apparatus. The user may edit a content such as an image being displayed on the image display apparatus using the augmented remote controller.

In a further example, when the type of detected augmented information is not suitable for being displayed on the display of the augmented remote controller, a screen of the display may be reconfigured.

For example, when the augmented information is too large in amount, the augmented remote controller may reduce a font size or contract an image (such as an icon) by a zoom-out so as to display more augmented information on its display.

When an image of a real environment captured by the camera of the augmented remote controller is displayed on the display, the augmented remote controller may zoom out the image of the real environment displayed on the display. Thus, the augmented remote controller may display an image of a wider scene of the real environment on the display than an augmented remote controller that displays an image of the real environment at an actual ratio. Additionally, the size of the object corresponding to the detected information may be reduced. As a consequence, the augmented remote controller may display a larger amount of augmented information near to the reduced object.

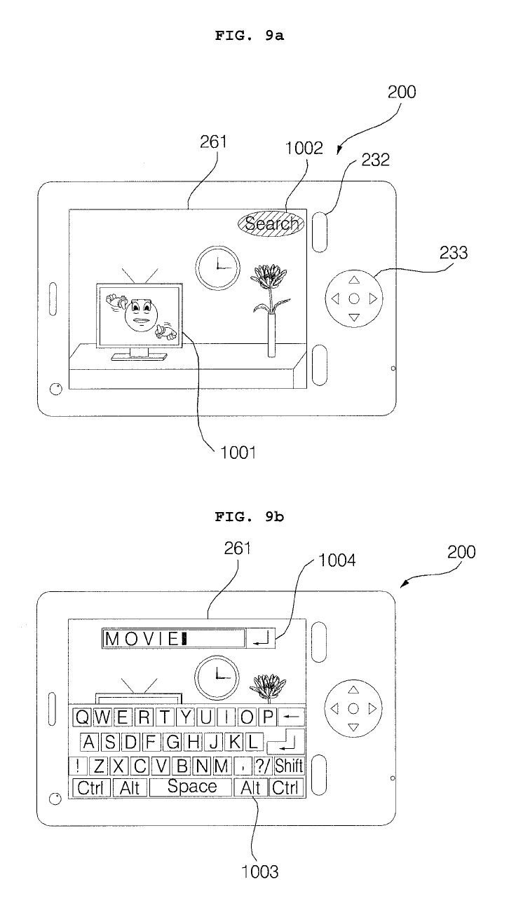

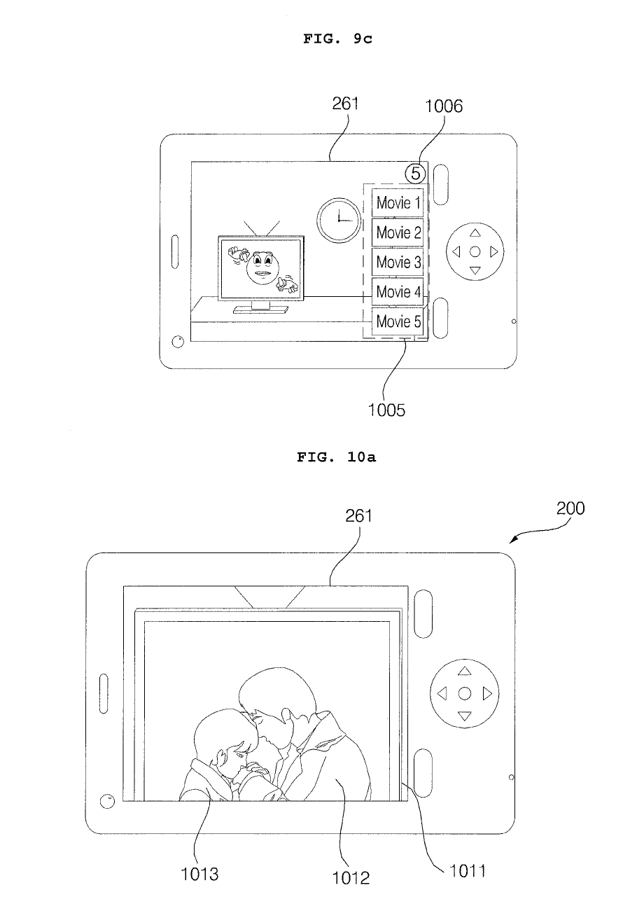

FIGS. 9A, 9B and 9C are views for describing an operation for using an augmented remote controller by a user according to an exemplary embodiment of the present invention. In the example of FIGS. 9A, 9B and 9C, when the user selects a search icon on the display of the augmented remote controller, a virtual keyboard may be displayed. The user may enter a keyword on the virtual keyboard and thus contents matching the keyword may be searched for in an external device.

Referring to FIG. 9A, the augmented remote controller 200 may include buttons 232 and a keypad 233 that the user may manipulate. The augmented remote controller 200 may further include a screen 261 for displaying search object-related information. The screen 261 of the augmented remote controller 200 with a transparent display may include a real environment projected onto the transparent display and search object-related information. Additionally, the augmented remote controller 200 may display an image of a real environment captured by the camera and search object-related information on the screen 261.

The screen 261 may include an image of a real environment captured by the camera and search object-related information, which should not be construed as limiting the present invention.

As shown in FIG. 9A, the screen 261 may include an image of a real environment captured by the camera of the augmented remote controller 200. The camera may be positioned to capture a real environment opposite to the user with respect to the augmented remote controller 200.

The image display apparatus 100 represented as a first object 1001 on the screen 261 may be an electronic device controllable by the augmented remote controller 200. In the exemplary embodiment, an electronic device capable of controlling another electronic device, such as the augmented remote controller 200, may be referred to as a controller device, and an electronic device that can be controlled by the controller device may be referred to as a target device. The image display apparatus 100 may be a target device controllable by a controller device.

In an exemplary embodiment, the image display apparatus 100 may be powered-on or powered-off. The augmented remote controller 200 may determine, for example, from a marker attached to the image display apparatus 100 that a current object captured by the camera is the image display apparatus 100. In another example, the augmented remote controller 200 may determine from a pattern of a captured image of the image display apparatus 100 that an object included in a current image captured by the camera is the image display apparatus 100.

In another exemplary embodiment, the augmented remote controller 200 may transmit a signal to and receive a signal from the image display apparatus according to a predetermined wireless communication standard. In this example, the augmented remote controller 200 may determine from metadata included in a received signal that a target device, which has transmitted the signal, is the image display apparatus 100. The augmented remote controller 200 may transmit signals to and receive signals from the target device by IR or RF communication.

The augmented remote controller 200 may also identify a target device through the home server 50 that stores information about the target device. That is, the augmented remote controller 200 may receive information regarding a current object projected onto the transparent display or captured by the camera from the home server 50 and acquire information regarding type of the target device and contents stored or played in the target device.

The user may search for contents that can be played in the target device through the augmented remote controller 200. As shown in FIG. 9A, the augmented remote controller 200 may display a second object 1002 for enabling the user to enter a keyboard display command to the screen 261. When the user touches the second object 1002 or manipulates an Enter key of the keypad 233 with the second object 1002 activated, the keyboard display command may be input to the augmented remote controller 200.

FIG. 9B illustrates the screen 261 of the augmented remote controller 200 when the keyboard display command has been entered. The augmented remote controller 200 may display a third object 1003 corresponding to a keyboard and a fourth object 1004 for displaying a character entered through the third object 1003.

The user may enter a keyword related to intended contents to be searched for through the third object 1003. The keyword may be displayed on the fourth object 1004. In accordance with this exemplary embodiment, the user may want to search for movie-related contents that can be displayed in the image display apparatus 100, which is a target device, and other electronic devices. Accordingly, the user may enter a keyword ‘MOVIE’ through the third object 1003 and thus the keyword ‘MOVIE’ may be displayed on the fourth object 1004.

FIG. 9C illustrates an example of displaying search results matching the user-input keyword on the screen 261.

Referring to FIG. 9C, an object 1005 representing search results for the input keyword may be displayed on the screen 261 of the augmented remote controller 200. The augmented remote controller 200 may also display an object 1006 indicating a number of search results matching the input keyword on the screen 261.

The search results may be movie-related contents that may be detected in the image display apparatus 100, which is a target device. The augmented remote controller 200 may display the object 1005 representing the contents available in the image display apparatus 100 on the screen 261.

The user may enter an object selection command to select an intended content to be played in the image display apparatus 100 in the object 1005 displayed on the screen 261 to the augmented remote controller 200. The augmented remote controller 200 may change the display status of the object corresponding to the object selection command. For example, the augmented remote controller 200 may highlight the selected object so that the user confirms his or her selected object.

The augmented remote controller 200 may transmit a content play command for the selected object to the image display apparatus 100. Thus, the image display apparatus 100 may play back the content corresponding to the content play command.

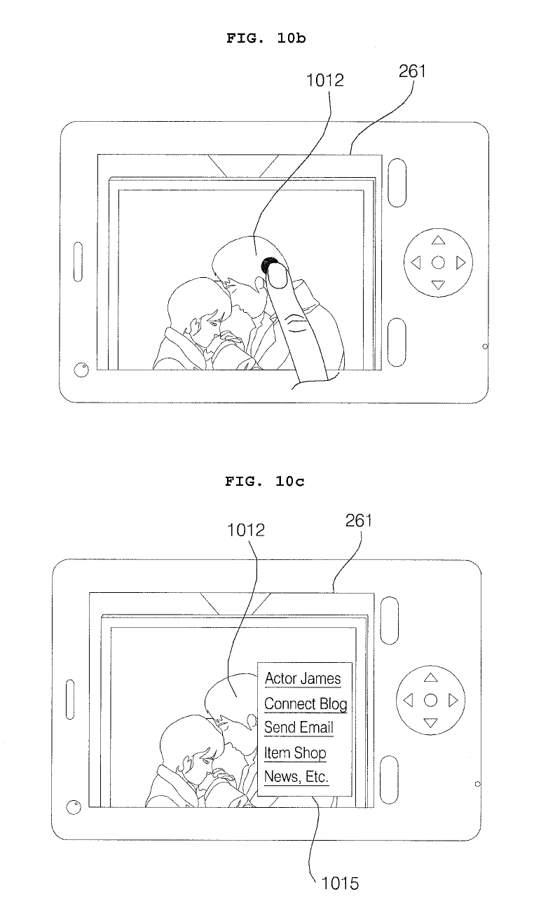

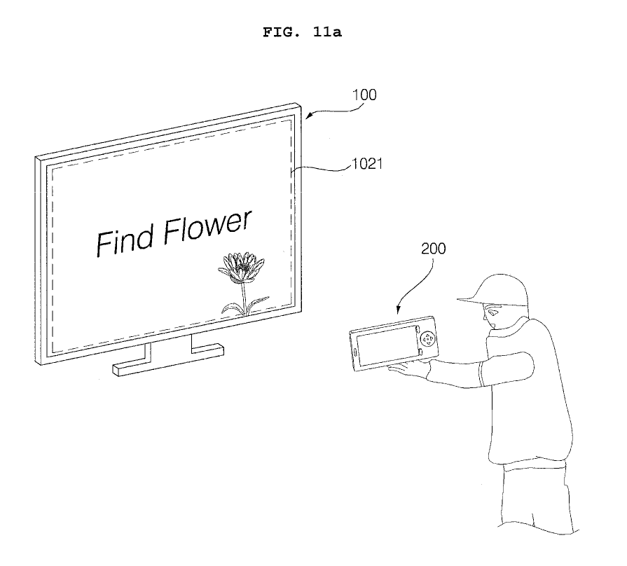

FIGS. 10A, 10B and 10C are views for describing screens displayed on an augmented remote controller according to an exemplary embodiment of the present invention. A particular object may be identified in a content displayed on the image display apparatus, information related to the identified object may be searched for in the network server in the Internet, and the determined information may be displayed. In this exemplary embodiment, the user may select an intended object from among objects displayed on the screen 261 to search for information related to the object. The augmented remote controller 200 may display the determined object-related information on the screen 261.

Referring to FIG. 10A, the user may manipulate the augmented remote controller 200 so that the image display apparatus 100 that the user is viewing is displayed on the screen 261. For example, the user may point the camera of the augmented remote controller 200 at the image display apparatus 100 that the user is viewing. In another example, the user may project the image display apparatus 100 that the user is viewing onto the transparent display of the augmented remote controller 200.

The screen 261 may display an object 1011 representing the image display apparatus 100 that the user is viewing. The user may view a current screen displayed in the image display apparatus 100 by the object 1011. In the exemplary embodiment, at least two objects are displayed on the screen of the image display apparatus 100. Accordingly, the augmented remote controller 200 may display at least two objects 1012 and 1013 on the screen of the image display apparatus 100 displayed on the screen 261.

The user may enter an object-related information search command for an object displayed on the screen 261 to the augmented remote controller 200. In this exemplary embodiment, the user may enter the object-related information search command to the augmented remote controller 200 by touching an intended object from among the objects displayed on the screen 261. FIG. 10B shows that the user touches the object 1012 on the screen 261.

FIG. 10C illustrates results of a search done according to the user-input search command, displayed on the screen 261 of the augmented remote controller 200. The object 1012 for which the user has entered the object-related information search command may represent an actor appearing in the current content played in the image display apparatus 100. The search results may include a name of the actor or Web contents related to the actor. The augmented remote controller 200 may display an object 1015 representing the search results on the screen 261.

The augmented remote controller 200 may determine information regarding the current content played in the image display apparatus 100 through the image display apparatus 100 or the home server 50 connected to the image display apparatus. The augmented remote controller 200 may determine an object appearing in the current content played in the image display apparatus using metadata received from the image display apparatus 100 or the home server 50 connected to the image display apparatus. The augmented remote controller 200 may identify or determine that the user-selected object 1012 is an actor appearing in the current content based on the metadata. The augmented remote controller 200 may determine information regarding the actor represented by the user-selected object 1012 by using the metadata.

The augmented remote controller 200 may search the Web, for example, using information regarding the user-selected object determined by the above methods (e.g. title of the content, name of the actor, etc.) and display search results from the Web on the screen 261.

The object 1015 representing the search results may be displayed superimposed on the object 1011 representing the image display apparatus 100. Thus, the user can view Web contents related to the actor from the object 1015 that describes information related to the user-touched object 1012.

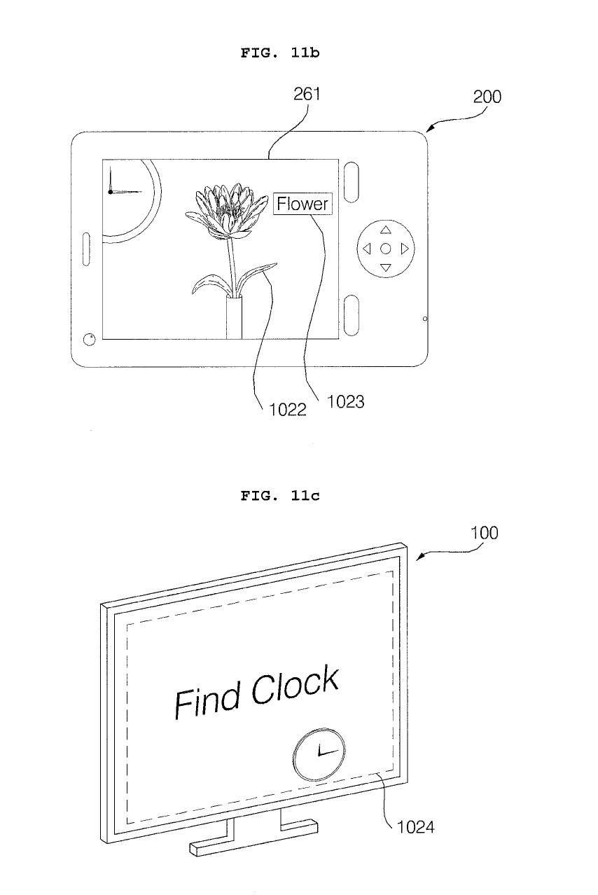

FIGS. 11A, 11B and 11C illustrate an example of searching for an object using the augmented remote controller 200 according to an exemplary embodiment of the present invention. The user of the augmented remote controller 200 may find a particular object using the augmented remote controller 200 according to text displayed on the image display apparatus 100. The augmented remote controller 200 may identify an object found by the user based on a marker attached to the object or an image pattern of the object and display information regarding the object on the screen 261. When the user finds the object according to the text displayed on the image display apparatus 100, the image display apparatus 100 may change its screen so that the user may find another object with the augmented remote controller 200.

In the method for searching for an object in the augmented remote controller, the augmented remote controller may identify a target device to which it can transmit a control command from among objects included in a real environment displayed on the screen of the augmented remote controller, identify an object displayed on the target device, identify an object in the real environment, compare the two objects, and when the two objects are identical, display the determination result on the screen.

Referring to FIG. 11A, the image display apparatus 100 may display an instruction 1021 to find a particular object on the display 180. The user of the augmented remote controller 200 may read the instruction 1021.

The user of the augmented remote controller 200 may find the particular object according to the instruction 1021 using the augmented remote controller 200. FIG. 11B illustrates an example of displaying the object found by the user on the screen 261 of the augmented remote controller 200. In this exemplary embodiment, the screen 261 may include an object 1022 representing a flower.

The object 1022 may be an image captured by the camera of the augmented remote controller 200. The object 1022 may be an image of a flower projected onto the transparent display.

The augmented remote controller 200 may identify that the object 1022 represents a flower by analyzing an image pattern of the object 1022 on the screen 261. In this exemplary embodiment, the augmented remote controller 200 may display an object 1023 representing information regarding the found object on the screen 261. In this exemplary embodiment, the information regarding the found object may be the name of the object.

When determining that the object found by the user matches the object that the image display apparatus 100 instructs the user to find, the augmented remote controller 200 may transmit a signal notifying that the instruction is fulfilled. The image display apparatus 100 may then display another instruction 1024 to find another object on the display 180 as shown in FIG. 11C.

After reading the changed instruction 1024 on the display 180 of the image display apparatus 100, the user may find the object indicated by the instruction 1024.

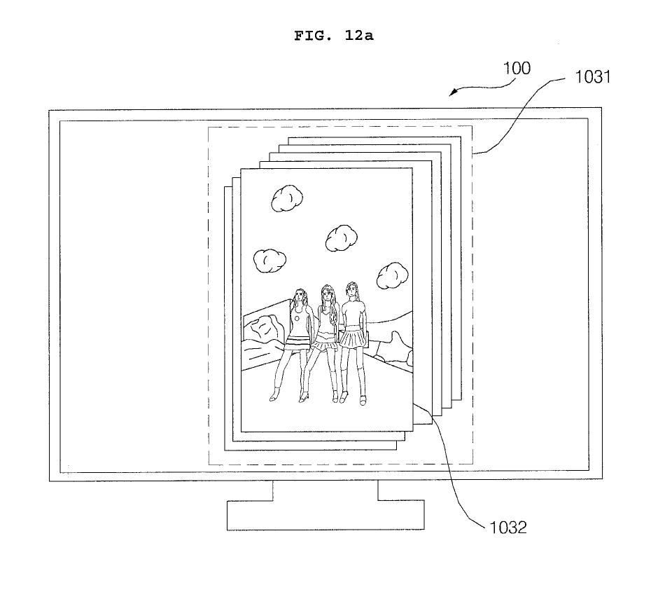

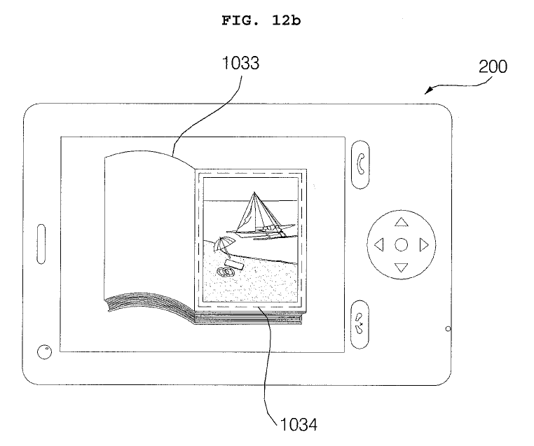

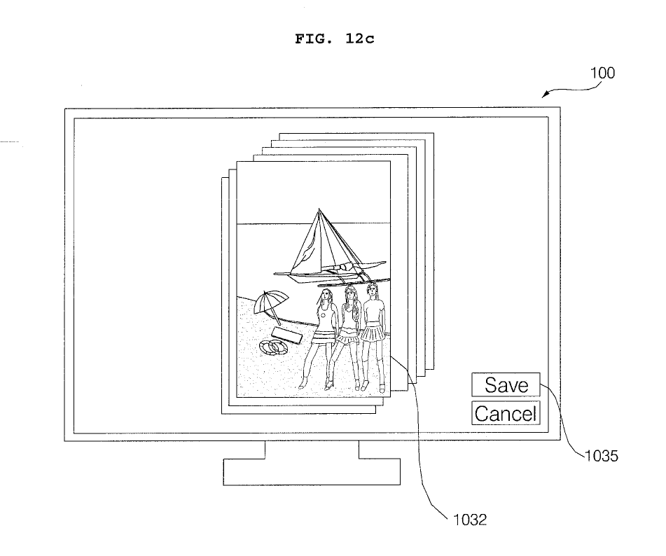

FIGS. 12A, 12B and 12C are views for describing an example of changing a screen displayed on the image display apparatus 100 using the augmented remote controller 200 according to an exemplary embodiment of the present invention.

Referring to FIG. 12A, the image display apparatus 100 may display an object 1031 representing photos taken by the user on the display 180. The user may input an object selection command to select a photo object 1032 from among a plurality of photo objects to the image display apparatus 100.

The image display apparatus 100 may display the photo object 1032 corresponding to the object selection command in front of the other photo objects. The user may confirm the photo object 1032 corresponding to the object selection command in the image display apparatus 100.

Referring to FIG. 12B, the user of the augmented remote controller 200 may capture an image 1034 included in an object 1033 representing a magazine, for example, by the camera of the augmented remote controller 200. The user may transmit the captured image to the image display apparatus 100 by manipulating a predetermined key or button of the augmented remote controller 200.

In another exemplary embodiment, after capturing the image 1034 included in the object 1033 by the camera of the augmented remote controller 200, the user of the augmented remote controller 200 may move the augmented remote controller 200 to point to the image display apparatus 100. Thus, the augmented remote controller 200 may determine that a send command to transmit the image 1034 to the image display apparatus 100 has been received. Accordingly, the augmented remote controller 200 may transmit the image 1034 included in the object 1033 to the image display apparatus 100.

Referring to FIG. 12C, the image display apparatus 100 may combine the received image with the selected photo object 1032. In this exemplary embodiment, the image display apparatus 100 may edit the photo represented by the selected object 1032 such that the received image becomes a background.

The user may enter a save command to store the edited photo object 1032 through the object 1035 displayed on the display 180 of the image display apparatus 100. The user may touch the save command object 1035 or use the augmented remote controller 200 to enter the save command. Upon receipt of the save command, the image display apparatus 100 may store the edited photo in the image display apparatus 100 or an external device connected to the image display apparatus 100.

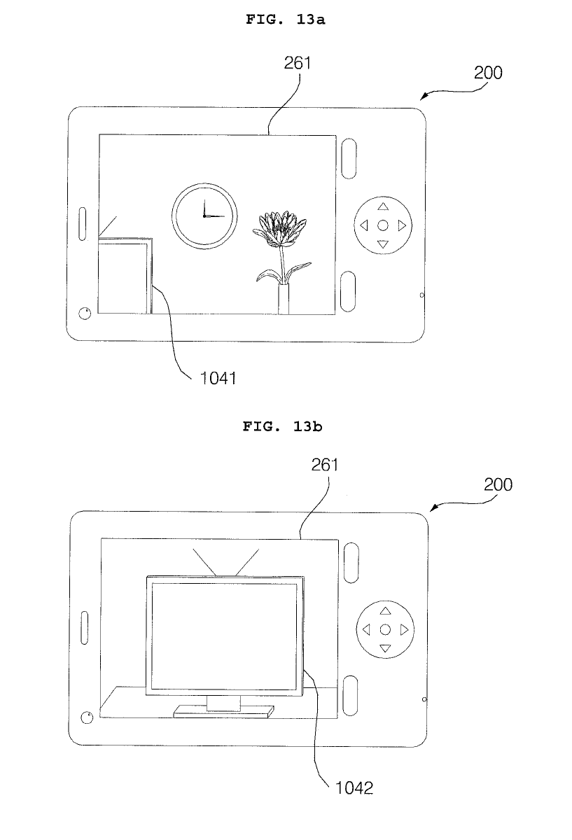

FIGS. 13A to 15B are views for describing screens displayed on the augmented remote controller 200 according to exemplary embodiments of the present invention.

A method for operating the augmented remote controller according to an exemplary embodiment of the present invention shown in FIGS. 13A and 13B may include determining whether there is a target device to which the augmented remote controller may transmit a control command in a real environment displayed on the screen of the augmented remote controller and changing the screen such that the target device is positioned at a center of the screen, in the presence of the target device in the real environment.

Referring to FIG. 13A, the user may manipulate the augmented remote controller 200 so that an image of a real environment is displayed on the screen 261. The image of the real environment may include an object 1041 representing the image display apparatus 100, which is a target device, controllable by the augmented remote controller 200.

The augmented remote controller 200 may identify or determine the image display apparatus 100 by reading a marker attached to the image display apparatus 100, recognizing an image pattern of the image display apparatus 100, and/or using information received from the home server 50 (including information regarding position of the image display apparatus 100, etc.).

When confirming that the object 1041 representing the image display apparatus 100 is included in the screen 261, the augmented remote controller 200 may change the screen 261 such that the object 1041 is enlarged on the screen 261.

Referring to FIG. 13B, the augmented remote controller 200 may adjust the camera so that it captures a full image of the image display apparatus 100. The augmented remote controller 200 may configure the screen 261 so as to include an object 1042 corresponding to the captured full image of the image display apparatus 100 in the screen 261.

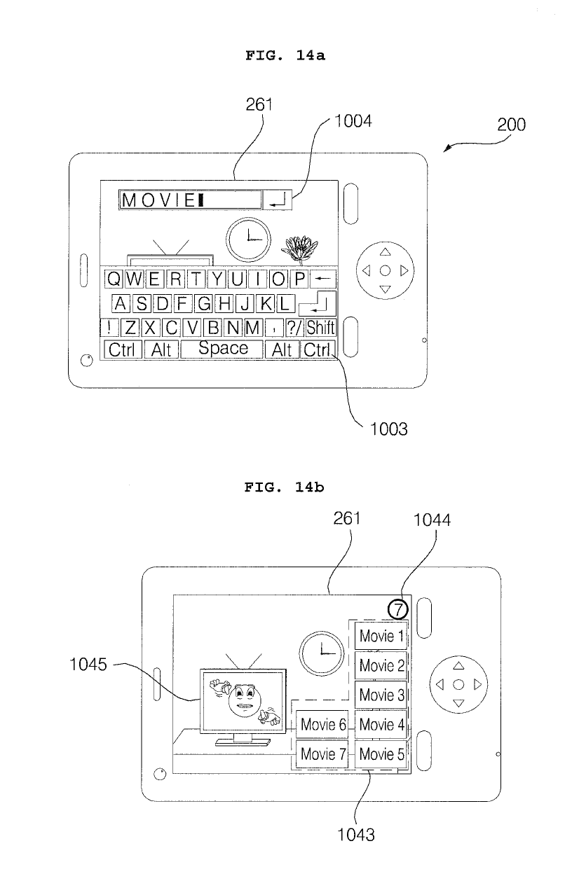

A method for operating the augmented remote controller according to an exemplary embodiment of the present invention shown in FIGS. 14A and 14B may include determining an area in which a target device to which the augmented remote controller may transmit a control command is displayed in an image of a real environment displayed on the screen of the augmented remote controller, determining an area in which related information is displayed on the screen, determining whether the related information is displayed overlapped with the target device, and changing the size of the display area of the target device or the related information, when the related information is displayed overlapped with the target device.

FIG. 14A illustrates an example of entering a keyword to search for playable contents in the image display apparatus 100 using the augmented remote controller 200.

In this exemplary embodiment, the augmented remote controller 200 may detect seven contents matching the user-input keyword. Referring to FIG. 14B, the augmented remote controller 200 may display an object 1043 representing the detected seven contents on the screen 261. The augmented remote controller 200 may also display an object 1044 indicating a number of the detected contents on the screen 261.

The augmented remote controller 200 may zoom out an image of the real environment in such a manner that the object 1043 does not overlap with the object 1044. Therefore, the user may view the object 1044 as well as the object 1043.

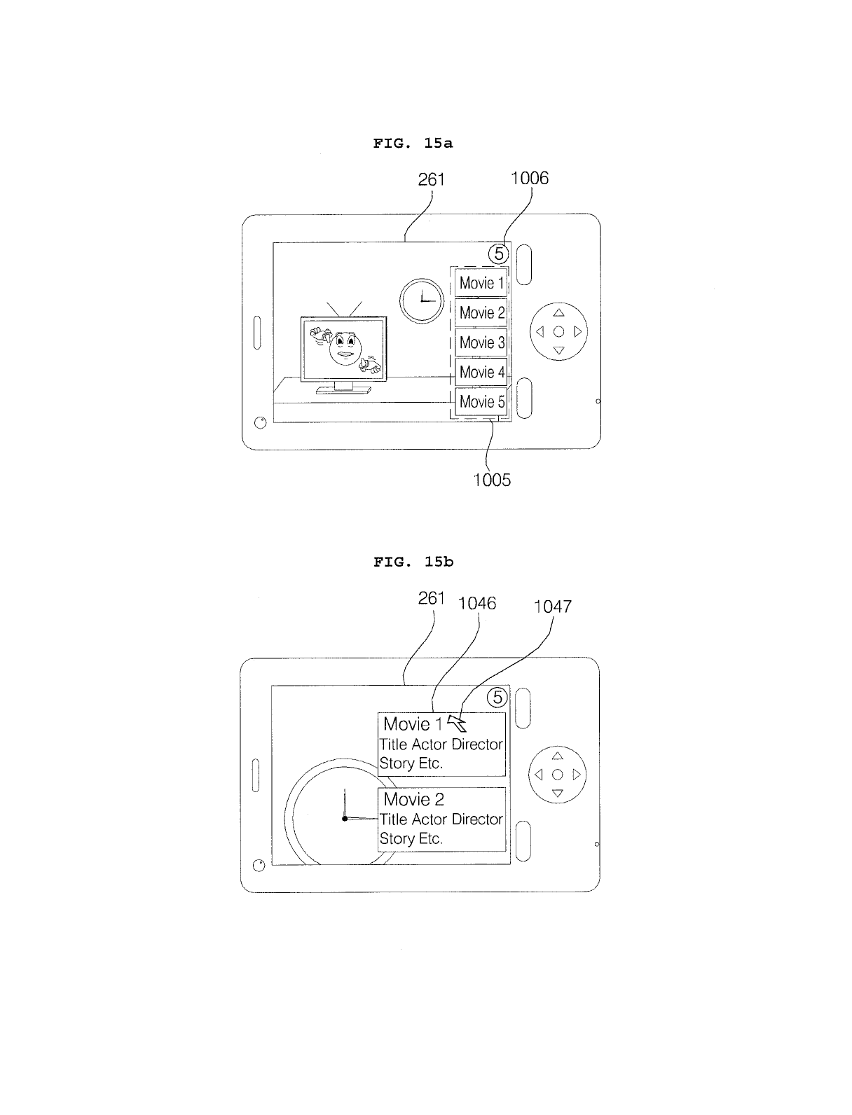

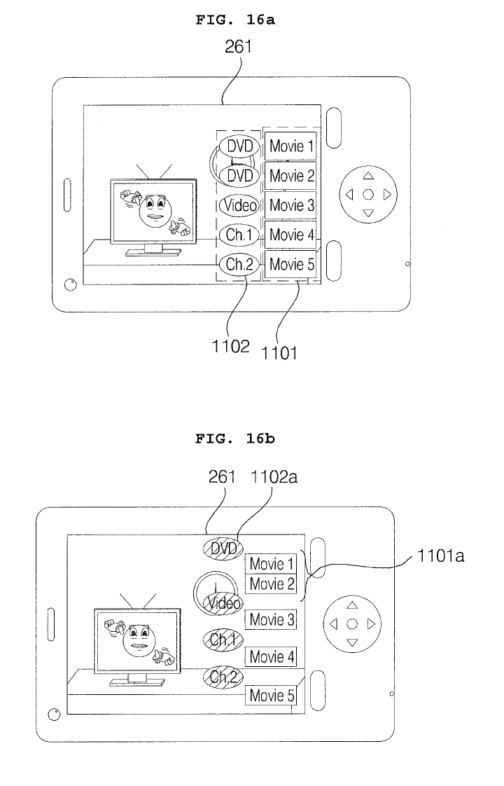

A method for operating the augmented remote controller according to an exemplary embodiment of the present invention shown in FIGS. 15A and 15B may include determining whether a command to change the display scale of an object corresponding to related information displayed on the screen, and changing the display scale of the object when it is determined that the display scale change command has been received.

FIG. 15A illustrates an example of displaying search results matching a user-input keyword in the augmented remote controller 200. The user may enter a zoom-in command to zoom in a particular object displayed on the screen 261 to the augmented remote controller 200.

FIG. 15B illustrates the screen 261 changed according to the zoom-in command. Referring to FIG. 15B, the augmented remote controller 200 may change the screen 261 such that the object 1046 representing the search results is enlarged.

To include more information in the enlarged object 1046, the augmented remote controller 200 may change the display state of the object 1046. The augmented remote controller 200 may add the title of a content corresponding to Movie 1, the name of an actor included in the content, and the producer name, synopsis, and other information of the content to the object 1046.

Additionally, the augmented remote controller 200 may create a cursor 1047 and display the cursor 1047 on the screen 261 so that the user can copy particular information included in the object 1046 or search for details regarding the particular information by use of the cursor 1047.

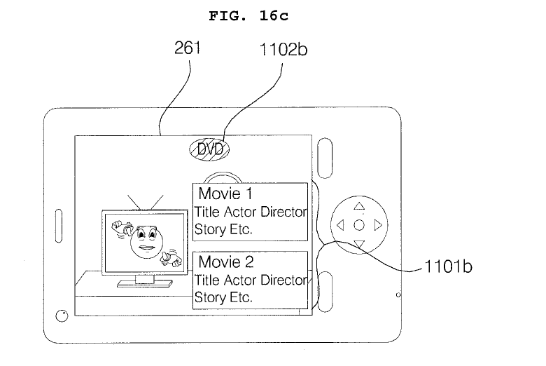

FIGS. 16A, 16B and 16C are views for describing a method for operating the augmented remote controller according to an exemplary embodiment of the present invention.

In this exemplary embodiment, the augmented remote controller 200 may display the object 1101 representing contents available from the image display apparatus 100 and an object 1102 representing places at which the contents are positioned, on the screen 261. The image display apparatus 100 may display an image based on a video signal received from a broadcasting station, the network server, and/or an external device. A content detected by the augmented remote controller 200 may be based on a video signal. Therefore, the augmented remote controller 200 may indicate whether a source that provides the video signal based on the content is the broadcasting station, the network server and/or the external device on the screen 261.

FIG. 16A illustrates the object 1102 representing stored places of the contents beside the object 1101 representing the contents. The user may be aware of where the contents are stored from the object 1102.

In another exemplary embodiment, the augmented remote controller 200 may arrange objects representing the contents according to places of the contents. FIG. 16B illustrates objects representing the contents, which are ordered according to their places.

Referring to FIG. 16B, the augmented remote controller 200 may display an object 1102a representing a DVD as an external device capable of providing contents to the image display apparatus 100. The augmented remote controller 200 may also display an object 1101a representing information regarding contents that can be provided from the DVD to the image display apparatus 100. Therefore, the user can view information regarding the contents that each external device can provide to the image display apparatus 100.

FIG. 16C illustrates an object 1102b representing a DVD as an external device capable for providing contents to the image display apparatus 100, displayed on the screen 261. The augmented remote controller 200 may further display an object 1101b that describes information regarding the contents in more detail. That is, the augmented remote controller 200 may provide information regarding titles, actors, producers, and synopses of the contents by the object 1101b.

An image display apparatus or an external device connected to the image display apparatus may be controlled by use of a single remote controller. Additionally, a user can efficiently use and manage contents played or stored in the image display apparatus or the external device connected to the image display apparatus, and information related to the contents.

The method for operating the augmented remote controller according to the foregoing exemplary embodiments may be implemented as code that can be written on a computer-readable recording medium and may thus be read by a processor. The computer-readable recording medium may be any type of recording device in which data is stored in a computer-readable manner. Examples of the computer-readable recording medium may include a ROM, a RAM, a CD-ROM, a magnetic tape, a floppy disc, an optical data storage, and a carrier wave (e.g., data transmission through the internet). The computer-readable recording medium may be distributed over a plurality of computer systems connected to a network so that computer-readable code is written thereto and executed therefrom in a decentralized manner. Functional programs, code, and code segments needed for realizing embodiments herein may be construed by one of ordinary skill in the art.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling an image display on a remote controller based on augmented reality, the method comprising:
identifying an electronic device having playable content;
displaying, on the screen, a window for entering a keyword related to playable content in the identified target device;
receiving the keyword in the window;
searching for content that corresponds to the received keyword entered through the window; and
displaying, on the screen, at least one object that represents determined content that corresponds to the received keyword.

2. The method according to claim 1, wherein the object that represents the determined content is displayed on the screen simultaneously with an object corresponding to the identified electronic device.

3. The method according to claim 1, further comprising:
determining a location in which the determined content is stored; and
displaying, on the screen, information regarding the determined location.

4. The method according to claim 3, wherein the location is one of an image display apparatus, an external device for providing content to the image display apparatus, or a network server for providing content to the image display apparatus.

5. The method according to claim 3, further comprising:
receiving an arrangement command to arrange the at least one object representing the determined content; and
displaying the objects representing the determined content according to the determined location and in response to receiving the arrangement command.

6. The method according to claim 1, further comprising:
receiving an object selection command to select intended content to be played; and
transmitting a command to play the content when the object selection command has been received.

7. The method according to claim 6, wherein the receiving the object selection command occurs when the object is dragged toward the identified electronic device displayed on the screen.

8. The method according to claim 1, further comprising:
determining a content being played in the identified electronic device;
receiving a command to select an object included in the determined content;
searching for information related to the selected object based on the received command; and
displaying, on the screen, the determined information based on the search.

9. The method according to claim 8, wherein searching for the information comprises:
determining the object corresponding to the command from among objects included in the content played in the identified electronic device;
requesting, from the identified electronic device, additional information regarding the determined object; and
searching for the information related to the object based on the additional information regarding the object received from the electronic device.

10. The method according to claim 8, wherein displaying the determined information includes displaying an object representing the determined information at a location of the screen near the selected object.

11. The method according to claim 1, further comprising:
determining an object displayed on the identified electronic device;
determining an object in the real environment of the remote controller;
determining whether the object displayed on the identified electronic device is similar or identical to the determined object in the real environment; and
displaying, on the screen, a determination result when the object displayed on the identified electronic device is similar or identical to the identified object in the real environment.

12. The method according to claim 11, wherein determining the object displayed on the identified electronic device comprises:
capturing the object displayed on the identified electronic device;
searching for information regarding the captured object based on an image pattern of the captured object; and
determining the captured object based on the determined information.

13. The method according to claim 11, further comprising transmitting a result of the determination to the identified electronic device.

14. The method according to claim 1, further comprising changing the screen to provide an image of the identified electronic device at a center of the screen.

15. The method according to claim 14, wherein changing the screen includes enlarging the image of the identified electronic.

16. A remote controller comprising:
a wireless communication unit;
an identification unit to identify an image display apparatus about the remote controller;
a display to display a screen that includes an image of a real environment and an object that represents information related to the real environment; and
a controller to control the display to display a window for entering a keyword related to playable content in the identified electronic device, the controller to further search for content that corresponds to an entered keyword, and to display an object that represents the determined content that corresponds to the received keyword.

17. The method according to claim 16, wherein the object that represents the determined content is displayed on the screen simultaneously with an object corresponding to the identified electronic device.

18. The remote controller according to claim 16, wherein the controller determines a location in which the determined content is stored, and controls the display to display information related to the determined location.

19. The remote controller according to claim 18, wherein the location in which the determined content is stored includes an image display apparatus, an external device for providing contents to the image display apparatus, or a network server for providing contents to the image display apparatus.

20. The remote controller according to claim 18, wherein the controller determines whether an arrangement command to arrange the objects representing the contents according to the determined locations has been arranged, and controls the display to display the objects representing the contents, arranged according to the determined locations when the arrangement command has been received.
